(19) United States
(12) Patent Application Publication
(10) Pub. No.: US 2005/0099129 A1
(43) Pub. Date: May 12, 2005

(54) Metal halide lamp used for both of vehicle headlight and infrared night imaging vision equipment, and metal halide lamp lighting apparatus

(75) Inventors: Toshihiko Ishigami, Kawasaki-shi (JP); Shigehisa Kawatsuru, Yokosuka-shi (JP); Mikio Matsuda, Tokyo (JP); Toshio Hiruta, Hiratsuka-shi (JP)

Correspondence Address: COOPER & DUNHAM, LLP, 1185 AVENUE OF THE AMERICAS, NEW YORK, NY, 10036, US

(73) Assignee: Harison Toshiba Lighting Corp.

(21) Appl. No.: 10/982,055

(22) Filed: Nov. 5, 2004

(30) Foreign Application Priority Data
Nov. 7, 2003 (JP) 2003-377813

(51) Int. Cl. H01J 17/20; H01J 61/12; H01J 61/20

(52) U.S. Cl. 313/637; 313/640

(57) ABSTRACT

A metal halide lamp used for both of a vehicle headlight and an infrared night imaging vision apparatus, comprises a refractory and light-transmitting hermetic vessel, a pair of electrodes sealed in the hermetic vessel, and a discharge medium sealed in the hermetic vessel. The discharge medium contains a first halide containing at least one of sodium, scandium and a rare earth metal, a second halide which is a halide of a metal which emits light mainly in a near-infrared region of a wavelength of 780 to 800 nm, and a gas which emits light mainly in a near-infrared region of a wavelength of 820 to 1000 nm, and does not substantially contain mercury.

### CROSS-REFERENCE TO RELATED APPLICATIONS

This application is based upon and claims the benefit of priority from prior Japanese Patent Application No. 2003-377813, filed Nov. 7, 2003, the entire contents of which are incorporated herein by reference.

### BACKGROUND OF THE INVENTION

1. Field of the Invention

The present invention relates to a metal halide lamp that can be used as a light source for both of a vehicle headlight and an infrared night imaging vision apparatus at the same time, and a metal halide lamp apparatus using the lamp.

2. Description of the Related Art

Various researches have been and are being made for the safety of driving automobiles. See, for example, “Journal of Illuminating Engineering Institute of Japan”, Volume 86, No. 12, pages 896 to 899, published 2002. This document discusses an infrared night imaging vision apparatus for an automobile, which serves as safety means of the automobile. The infrared night imaging vision apparatus for the automobile is called “Night Vision (trade mark)”, which is a support system for drivers to drive safely during night. This apparatus was developed as auxiliary means for drivers to assure a viewability of obstacles including pedestrians in front of the automobile and traffic signs, and it operates by utilizing the characteristics of the infrared radiation. The apparatus has been merchandized in the United States for the first time in 1999. The infrared night imaging vision apparatus shoots an obstacle, etc. in such a distance that it cannot be viewed only with the front light by an infrared camera, and displays the shot vision for the driver to be able to view the obstacle. Since the infrared light has a wavelength longer than that of visible light, the apparatus is not affected by, for example, the brightness of the front light of an oncoming vehicle. Further, as compared to the case where the driver directly sees an obstacle by visible light in rain or fog, the apparatus has a better performance in detecting the obstacle.

There are two types of infrared night imaging vision apparatus for automobiles, namely, a passive type and an active type. The passive type detects the far infrared light (having a wavelength of 8 to 14 μm) radiated from an obstacle with a far infrared camera. This type of apparatus entails the drawbacks of the cost of the camera being high and the vision recognition being lower in such climates as rain and snow. By contrast, the active type projects near-infrared light onto an obstacle using a projector, and detects its reflection light with a near-infrared-sensitive CCD camera. The conventional light source for an infrared night imaging vision apparatus used for a projector has such a structure that a halogen lamp and a wavelength selecting filter are combined together, and it projects near-infrared light having a wavelength of 780 nm to 1.2 μm. This type is advantageous because the camera used here is at low cost and it is possible to have visual recognition close to images by visible light. It should be noted that both of the types described above are designed to display a detected image on a head up display or head low display.

As a known example of the light source for infrared night imaging vision apparatus of the active type, there is a lamp unit that includes a discharge tube in which cesium halide is sealed in its hollow section and a near-infrared radiation transmitting filter provided around the tube. See Jpn. Pat. Appln. KOKAI Publication No. 2003-257367. The lamp unit discussed in this patent document emits near-infrared radiation by electric discharge using either one of cesium iodide or cesium bromide as the cesium halide, and selectively extracts the near-infrared line with the near-infrared radiation transmitting filter provided around the lamp. Thus, this document describes the intention of the invention that the lamp unit is used as an exclusive light source for the infrared night imaging vision apparatus. Further, the patent document describes that the near-infrared radiation transmitting filter is provided to be retractable from the surrounding of the discharge tube, and thus the lamp can be switched to the light source of the fog lamp of the vehicle. Therefore, when used as the exclusive light source for the night vision apparatus, the lamp unit of this patent document cannot be used as a vehicle headlight.

In spite of the above-described advantageous points as compared to the passive type, the active type infrared night imaging vision apparatus for automobile conventionally require an exclusive light source at least when the infrared night imaging vision apparatus is in operation. Consequently, another separate light source must be installed in addition to the front light of the automobile or a fog light of a complicated structure including movable parts must be employed, and accordingly, the cost for the equipments is increased.

As a solution to the above-described problem, the inventor of the present invention, prior to this, achieved an invention of a metal vapor discharge lamp as an embodiment that carry out the invention. The metal vapor discharge lamp includes a light source co-used as that for a front light of an automobile and that for an infrared night imaging vision apparatus. This application was filed as Jpn. Pat. Appln. No. 2002-294617 (to be called “prior invention” hereinafter for the same of convenience).

On the other hand, in Europe, there was a bill named “End of Life Vehicles” (ELV) proposed in September 1996, which orders the reduction of Hg step by step and eventually the complete removal of it from commercially available vehicles. The bill proposed by the EU (European Union) was passed and approved by the European Parliament on Feb. 3, 2000. Thus, the use of Hg was inhibited as a rule. The front light that employs a mercury-free HID lamp was approved by the congress of GRE (Groupe de Rapporteuss le Eclairage) in October 2002, and adopted as an European vehicle regulation (ECE Regulation) in July 2003. With this regulation in force, the Hg-sealed HID front lights will be all shifted to the mercury-free type in the near future. It should be noted that it is expected that the standardization of the mercury-free HID lamp for the front light will be completed soon.

The prior invention discloses a general scope of a light source that is co-used as that for the front light of an automobile and that for the infrared night imaging vision apparatus, as an embodiment carried out by the invention. This invention, however, does not cover the above-described mercury-free type lamp which is expected to be standardized, that falls in a suitable range as the light source for the near-infrared type night imaging vision apparatus.

### BRIEF SUMMARY OF THE INVENTION

The object of the present invention is to provide a metal halide lamp that can satisfy the requirements for a mercury-free type automobile front light, which is expected to be standardized, and be used as both of the front light of an automobile and the infrared night imaging vision apparatus, which is suitable as the light source for a near-infrared type night imaging vision apparatus.

According to the first aspect of the present invention, there is provided a metal halide lamp used for both of a vehicle headlight and an infrared night imaging vision apparatus, comprising: a refractory and light-transmitting hermetic vessel; a pair of electrodes sealed in the hermetic vessel; and substantially mercury-free discharge medium sealed in the hermetic vessel and including a first halide containing at least one of sodium (Na), scandium (Sc) and a rare earth metal, a second halide which is a halide of a metal which emits light mainly in a near-infrared region of a wavelength of 780 to 800 nm, and a gas which emits light mainly in a near-infrared region of a wavelength of 820 to 1000 nm.

In the above-described invention and each invention described below, the terms used have the following definitions and technical meanings if they are not particularly designated:

<Regarding Hermetic vessel> The hermetic vessel must be of a refractory and light-transmittable type. The internal volume of the container is, since it is used as the headlight, 0.005 to 0.1 cc in general, and preferably, 0.01 to 0.05 cc. The hermetic vessel being “refractory and light-transmitting” means that the container is made of a material that is strong enough to resist the standard operation temperature of discharge lamps. Accordingly, the hermetic vessel may be formed of any material if the material is refractory and can transmit, to the outside thereof, visible light of a desired wavelength area emitted by discharge. For example, it may be polycrystal or monocrystal ceramics, such as quartz glass, light-transmitting alumina, YAG. When necessary, it is allowed to form, on the inner surface of the hermetic vessel, a light-transmitting film having a resistance against halogens or metals, or to improve the quality of the inner surface of the hermetic vessel. Further, it is preferable that the hermetic vessel should have a maximum inner diameter of 2 to 10 mm and a maximum outer diameter of 5 to 13 mm.

The hermetic vessel includes an enclosure portion and a pair of sealing sections. The enclosure portion has a discharge space formed therein having an appropriate shape, preferably, a long and narrow discharge space. The long and narrow discharge space may be of a substantial cylinder. By virtue of this shape, in horizontal lighting, the arc is liable to warp upwards and approach the inner surface of the upper portion of the hermetic vessel, which accelerates the increase of the temperature of the upper portion. Furthermore, the portion surrounding the discharge space can be made relatively thick. In other words, the portion located at substantially the intermediate position between the electrodes can be made thicker than both ends. As a result, the heat transmittance of the hermetic vessel is increased to thereby accelerate the temperature increase of the discharge medium stuck to the inner surfaces of the lower and side portions of the container, with the result that the rise of a luminous flux is accelerated.

The pair of sealing sections serve to seal the enclosure portion and support the axial portions of the electrodes. The sealing sections are also means to airtightly introduce currents from the lighting circuit to the electrodes, and they are formed integrally with the enclosure portion to stretch out from both side of the enclosure. In addition, to seal the electrodes and airtightly introduce currents from the lighting circuit to the electrodes, and in the case where the material of the hermetic vessel is quartz glass as preferred, sealed metal foils are airtightly buried in the sealing sections as appropriate airtight sealing and conducting means. It should be noted that the sealed metal foils are means buried inside the sealing portions so as to function as current conductors while cooperating with the sealing portions to maintain the airtightness in the enclosure portion of the vessel. When the hermetic vessel is made of quartz glass, the most preferable material for the metal foils is molybdenum (Mo). Since molybdenum becomes oxidizable when the temperature is about 350° C. or higher, the metal foils are buried such that the temperature of the outer side end portion becomes lower than this temperature. The method of burying the sealed metal foils in the sealing sections is not particularly limited, but preferable examples thereof are a reduced-pressure sealing method, a pinch sealing method and a combination of both, which may be selected in accordance with necessity. In the case of a metal halide lamp used for a vehicle headlight, having an internal volume of small as 0.1 or less, and in which a gas of, for example, xenon (Xe) is sealed at 6 atmospheres or more at room temperature, the latter method is appropriate.

<Pair of Electrodes> The pair of electrodes are sealed in the hermetic vessel to be directed towards the discharge space. It is preferable that the distance between the electrodes should be 5 mm or less, or more preferably, 4.2±0.3 mm. The electrodes have a linear axial portion preferably having substantially the same diameter in the longitudinal direction. The diameter of the axial portion is, preferably, 0.25 mm or more, and more preferably 0.45 mm or less. The diameter of the axial portion is substantially constant without being increased to its distal end. The distal end of each electrode is formed flat, or has a curved surface or truncated cone serving as the starting point of an arc. Alternatively, the distal end may be formed to a larger diameter than the axial portion.

In addition, the pair of electrodes can be formed of a refractory and conductive metal such as pure tungsten (W), doped tungsten, rhenium (Re) or a tungsten-rhenium alloy (W—Re), etc.

<Regarding Discharge Medium> The discharge medium is sealed inside the hermetic vessel, and it serves as a medium that makes discharge to occur. The discharge medium contains a first halide, a second halide and a rare gas, but almost no mercury.

(First Halide) The first halide includes at lease one of sodium (Na), scandium (Sc) and an rare earth metal, and serves as a metal that emits light of mainly a visible range. It is preferable that the first halide should contain sodium (Na) and scandium (Sc), and when desired, a rare earth metal should be added thereto. With these contents, white light can be emitted at a high efficiency. Examples of the rare-earth metal are dysprosium (Dy) and thulium (Tm).

(Second Halide) The second halide is a halide of a metal that emits light mainly in a near-infrared wavelength range of 780 to 800 mm. In the present invention, the expression “emitting light mainly in a near-infrared wavelength range” is used to mean such a concept that includes cases where a wavelength region that has the maximum radiation energy is present in the near-infrared region and a wavelength region that has an effective radiation energy that can surely contribute to an infrared night imaging vision apparatus is present in the near-infrared region, regardless of whether the spectrum of the emitted light is of an emission line spectrum or continuous spectrum. This is because the present invention, in either of these cases, can radiate effective near-infrared light as a light source for an infrared night imaging vision apparatus. Nevertheless, when a wavelength region that has the maximum radiation energy is present in the near-infrared region, the radiation energy of the infrared light to make the infrared night imaging vision apparatus sensible becomes minimum. Accordingly, the radiation energy that can be used for emitting visible light can be increased, which is further preferable.

In general, the term “near-infrared region” means a range of a wavelength of 780 nm to 2 μm. Of such a wavelength range, a metal that emits light mainly in a near-infrared wavelength range of 780 to 800 nm described above is sufficient for the present invention. Further, the metal contained in the second halide may be one type or two or more types of those metals that satisfy the above-described condition. The radiation energy of a near-infrared region of a wavelength of 780 to 800 nm can be sensed by the vehicle infrared night imaging vision apparatus at a high sensitivity. The most appropriate example of the metal is rubidium (Rb). It should be noted that cesium (Cs) is not appropriate to be contained in the second halide of the present invention for the following reason. That is, cesium (Cs), in an ordinary operation pressure of a metal halide lamp of this type of metal, emits light of emission line spectrum in a range of a wavelength of 760.9 to 1012.0 nm as will be described later; however this element exhibits main light emission within a range of 840 to 930 nm. Thus, the radiation energy of an infrared region of a wavelength of 780 to 800 nm does not have effective radiation energy that can surely contribute to the infrared night imaging vision apparatus.

FIG. 1 is a graph illustrating characteristic curves of spectral distributions of metal halide lamps containing discharge media of the first and third halides and a gas of ScI₃—NaI—ZnI₂—Xe sealed therein, in one of which RbI is sealed, whereas in the other of which CsI is sealed, as the characteristic curves are superimposed one on another. This figure shows a curve of the sensitivity characteristics of a CCD camera shown in FIG. 5, which will be described later, as it is further superimposed thereon.

Rubidium (Rb) has emission lines of wavelengths of 761.9, 775.7, 775.9, 780.0, 794.7 and 887.3 nm. As can be understood from FIG. 1, this element emits light prominently in a wavelength range of 770 to 800 nm, especially, 780 to 800 nm. By contrast, cesium (Cs), as indicated by a dotted line in FIG. 1, has emission lines prominently in a range of 800 to 900 nm. Due to the sensitivity characteristics of the CCD camera, the substantial effect with respect to the infrared night imaging vision apparatus is better in the light emission of rubidium (Rb). For the same radiation power of the near-infrared region, the effect is increased by 35% as compared to the case of cesium (Cs). In the case of an actual lamp, the near-infrared region contains light emission of sodium (Na) (at wavelengths of 818.3, 819.4, 1138.1, 1140.1 nm), that of xenon (xe) (wavelength of 820 to 1000 nm), etc. Therefore, the difference in the effect is actually smaller than that, but even in the actual case, the effect is still increased by about 15 to 20%.

Further, the halogens that constitute the first and second halides will now be described. That is, in terms of reactivity, iodine is most appropriate. At least the above-described main light emission metals are sealed in the form of iodides. However, when needed, different halide compounds such as a combination of iodide and bromide can be used.

(Gas) The gas used in the present invention is of a type that emits light mainly in a near-infrared wavelength range of 820 to 1000 mm. As in the case of the second halide, the expression “emitting light mainly in a near-infrared wavelength range” is used to mean such a concept that includes cases where a wavelength region that has the maximum radiation energy is present in the near-infrared region and a wavelength region that has an effective radiation energy that can surely contribute to an infrared night imaging vision apparatus is present in the near-infrared region, regardless of whether the spectrum of the emitted light is of an emission line spectrum or continuous spectrum. This is because the present invention, in either of these cases, can radiate effective near-infrared light as a light source for an infrared night imaging vision apparatus. The radiation energy in a near-infrared region of a wavelength of 820 to 1000 nm is sensed by the vehicle infrared night imaging vision apparatus at a high efficiency. In the present invention, the type of gas is not particularly limited; however it has been found that the most appropriate gas that satisfies the above-described condition is xenon (Xe).

To explain, xenon (Xe) has emission lines, in a near-infrared region, at wavelength of 823.1, 881.9, 895.2, 904.5, 916.2, 937.4, 951.3, 979.9 and 992.3 nm, and thus it radiates radiation energy in the above-described near-infrared region. FIG. 2 is a graph showing a spectral distribution curve of a lamp in which only xenon is sealed. In this figure, the indications of the wavelengths are expressed in numeral values without digits of the right side of the decimal point for simplification. The wavelength distribution of the radiation in the near-infrared region can be understood from this figure.

FIG. 3 is a graph illustrating characteristic curves of spectral distributions of a metal halide lamp containing discharge media of the first and third halides and a gas of ScI₃—NaI—ZnI₂—Xe sealed therein, in which the Xe light emission is estimated. This figure is prepared by superimposing the light emission using Xe solely estimated from FIG. 2. In this figure, the indications of the wavelengths are expressed in numeral values without digits of the right side of the decimal point for simplification.

As can be understood from FIG. 3, the emission lines indicated by “Na” in the figure are emission lines having wavelengths of Na of 818.3 and 819.4 nm, and also an emission line of Xe of a wavelength of 823.1 nm, which is close to the wavelengths of Na is superimposed. As described above, part of the light emission in the near-infrared region of the metal halide lamp used for both the vehicle headlight and infrared night imaging vision apparatus, according to the present invention is due to the basic structural part of the lamp. It should be noted that the continuous light emission observed in a wide range in the figure is by electrons.

However, solely with the Na light emission, Xe light emission and continuous light emission due to electrons as shown in FIG. 3, it is not possible to obtain such a near-infrared radiation power that is necessary as a light source of the infrared night imaging vision apparatus to cover a desired range of visibility, which can be a long distance. As a solution to this, a halide of rubidium (Rb) is sealed as the second halide in the present invention. With this material, it becomes possible to obtain a desired range of visibility.

Further, xenon (Xe) serves not only as a starting gas and buffer gas of the metal halide lamp used for both the vehicle headlight and infrared night imaging vision apparatus, according to the present invention, but also as the followings. That is, immediately after the turning-on, the lamp emits white visible light in a stage where the vapor pressure of the halide is still low. Here, the xenon gas sealed in at an appropriate pressure contributes to the rise of luminous flux as it is needed. At the same time, it greatly contributes to increase the radiation of the near-infrared region. The preferable sealing pressure of xenon is 6 atmospheres or higher, preferably, in a range of 8 to 16 atmospheres. Within this range, the radiation energy of the near-infrared region can be increased, and further the white light emission of xenon can contribute to the rise of the luminous flux immediately after starting of lighting where the partial pressure of the light emission metal is still low. In this manner, the specification of the white light emission as an HID lamp for the vehicle headlight can be satisfied even immediately after the start of lighting.

(Mercury) Mercury will also be described. In the invention, the feature that “the discharge medium contains substantially no mercury” means not only that no mercury is contained, but also that the existence of mercury of 0.5 to 1 mg, or in some cases, about 1.5 mg, per internal volume of 1 cc is allowed. Of course, it is desirable for the environment to contain no mercury. However, as compared to the conventional cases where mercury of 20 to 40 mg, 50 mg or more in some cases, is contained per internal volume of 1 cc of a short-arc type hermetic vessel to increase the lamp voltage to a required value using mercury vapor, it can be said that the amount of mercury is substantially very small.

Regarding Function of the Invention

By virtue of the above-described structure, the present invention exhibits the following function.

1. When the metal halide lamp of the present invention is connected to a lighting apparatus to light the lamp, visible light is generated by the metal contained in the first halide in the discharge medium and near-infrared line having a wavelength of 780 to 800 nm is generated by the metal contained in the second halide. In addition, near-infrared line having a wavelength of 820 to 1000 nm is generated by the discharge of the gas.

More specifically, sodium (Na), scandium (Sc) or the rare earth metal, which constitutes the first halide radiates mainly white visible light. However, sodium (Na) has, other than the strong visible characteristic spectrum (light beam) so-called D lines, a strong light line at a wavelength of 819.4 nm in the near-infrared region, and further has relatively strong light lines at 1138.1 and 1140.1 nm. These near-infrared light lines, particularly, the 819 nm-light line, contribute also to the light source of the infrared night imaging vision apparatus.

The visible light here can be adjusted to satisfy the specifications for the vehicle head light, for example, JEL-215-1998 of the Japan Electric Lamp Manufacturers Association, by appropriately selecting the light emitting metal that constitutes the first halide and the amount of the metal sealed. It should be noted that the specifications are set at a rated input of 35±3 W, and in the case of D2S type, the total luminous flux is 3200±450 lm, whereas in the case of D2R, the total luminous flux is 2800±450 lm.

The near-infrared light of a wavelength of 780 to 1000 nm is generated by the first and second halides and the gas as described above. Therefore, the metals contained in the first and second halides and the amounts of these sealed should be appropriately selected, and the type of gas and the sealing pressure should appropriately be selected. In this manner, the necessary amounts of these can be easily obtained while maintaining a necessary amount of visible light at the same time.

2. In the case of the active type infrared night imaging vision apparatus for a vehicle, it is equipped with a CCD image pickup device, and the sensitivity characteristics of its near-infrared line camera have a peak near a wavelength of 759 nm and gradually decrease towards the longer wavelength side. However, this CCD image pickup device has such sensitivity characteristics that it is sensitive up to around a wavelength of 1200 nm.

As described above, the metal halide lamp used for both of a vehicle headlight and an infrared night imaging vision apparatus according to the present invention, generates both of near-infrared light of a wavelength of 780 to 1000 nm and visible light at the same time. Therefore, it can be understood that the near-infrared light is utilized as the light source for the infrared night imaging vision apparatus and the visible light can be utilized for lighting the vehicle headlight while satisfying the before-described specifications of the lamp, at the same time.

3. According to the present invention, the gas that radiates near-infrared light can be also utilized as a starting gas as well as buffer gas such as xenon (Xe), and further, it can be constituted to include an element that radiates visible light. With this structure, white visible light is supplemented mainly in the rise of the luminous flux immediately after the start of lighting. While the lamp is lit, the gas functions as a buffer gas to maintain the heat of the plasma in place of mercury. Therefore, when the sealing pressure of the gas is increased, the heat loss of the metal halide lamp is decreased and the total luminous flux is increased. For this reason, it becomes easier to satisfy the specifications as the light source for the vehicle headlight.

Further, the above-described gas radiates near-infrared light separately besides the second halide. This near-infrared light can be utilized as the light source for the infrared night imaging vision apparatus. Therefore, it becomes easier to assure a necessary amount of visible light as the light source for the vehicle headlight. Accordingly, the amount of the second halide sealed can be decreased to the lowest possible level, to make the lamp to generate more visible light by a corresponding amount.

4. The followings are examples of the vehicle headlight in which the metal halide lamp used for both of a vehicle headlight and an infrared night imaging vision apparatus according to the present invention, can be mounted. That is, such vehicle headlights are of a projector 4-light system, a reflector 4-light system, a projector 2-light system and a reflector 2-light system.

The projector 4-light system uses a set of two metal halide lamps of a D3S or D4S type for the low beam and a set of two halogen lamps for the high beam. In this system, of the light radiated from the metal halide lamp, the light beam portion radiated in the high-beam direction is cut by placing a light shield member for the headlight. In the metal halide lamp used for both of a vehicle headlight and an infrared night imaging vision apparatus according to the present invention, only the near-infrared light of the light radiated in the high-beam direction is selectively guided out with use of, for example, a near-infrared light filter. Thus, the near-infrared light can be used as the light source for the infrared night imaging vision apparatus. The reflector 4-light system uses a set of two metal halide lamps of a D3R or D4R type for the low beam and a set of two halogen lamps for the high beam. As a shielding film for preventing unnecessary glare is formed on an outer tube of a metal halide lamp of a D3R or D4R type to obtain a metal halide lamp of a D3R or D4R type, respectively. The aspect that two halogen lamps are used for the high beam is similar to that of the projector 4-light system. It should be noted that the D3S and D3R types have similar specifications to those of the D4S and D4R types, respectively, except that an igniter is provided at a base section of the lamp.

By contrast, the projector 2-light system has such a structure that the lighting positions of the two metal halide lamps of the D3R or D4R are switched between the low beam mode and high beam mode. In order for the switching means here, for example, a light shielding plate is mechanically moved. The reflector 2-light system has such a structure that the lighting positions of the two metal halide lamps of the D4R are switched between the low beam mode and high beam mode. In order for the switching means here, for example, the positions of the metal halide lamps are mechanically moved.

Next, the operation principle of the active type infrared night imaging vision apparatus when the metal halide lamp used for both of a vehicle headlight and an infrared night imaging vision apparatus according to the present invention is used will now be described with reference to FIGS. 4 and 5. FIG. 4 is a conceptual figure that illustrates the operation principle of the active type infrared night imaging vision apparatus and FIG. 5 is a graph that illustrates a spectral sensitivity characteristic curve of a CCD camera used for the infrared night imaging vision apparatus. In FIG. 4, reference symbol HD denotes the vehicle headlight, NC denotes the infrared night imaging vision camera and HM denotes an obstacle.

The vehicle headlight HD is equipped inside with the metal halide lamp used for both of the vehicle headlight and the infrared night imaging vision apparatus according to the present invention, and visible light VL radiated by lighting the lamp is directed to outside to form an irradiation pattern of the low beam mode. By contrast, the near-infrared light IR radiated at the same time as that of the visible light VL by the lighting is separated from the visible light VL with use of, for example, a visible light shielding member, and directed in the high beam mode direction to irradiate the front of the vehicle.

The infrared night imaging vision camera NC is installed aboard the vehicle. The camera NC shoots an obstacle HM such as a pedestrian in front of the traveling vehicle, that is irradiated with the near-infrared light projected from the vehicle headlight HD, and displays the shot image on, for example, a head up display (not shown) so that the driver in the automobile can recognize it. The infrared night imaging vision camera NC includes a semiconductor image pickup device that is sensitive to the near-infrared light, such as a CCD image pickup device. The CCD image pickup device is used widely as-a CCD camera, and it has the spectral sensitivity characteristics shown in FIG. 2.

More specifically, in the near-infrared region, there is a peak in its sensitivity near a wavelength of 759 nm, and the sensitivity is very high in a wave-length range of 780 to 800 nm. In a wavelength range of 800 to 930 nm, the sensitivity is still fairly high. Further, in a wavelength range of 780 to 1000 nm, the camera is sensible. It should be noted here that in order to suppress the sensitivity to the visible light, an infrared light filter may be used for the camera NC.

Therefore, as the radiation power of the near-infrared light radiated from the vehicle becomes higher, the range of shooting for the infrared night imaging vision apparatus becomes longer and the range of visibility becomes longer. On the other hand, as viewed from the obstacle HM side, for example, a pedestrian side, if the near-infrared light is irradiated from the oncoming vehicle, he or she does not have a feeling of being exposed to glare very much.

According to the second aspect of the present invention, there is provided a metal halide lamp used for both a vehicle headlight and an infrared night imaging vision apparatus that is similar to the metal halide lamp of the first aspect, characterized in that a ratio between a radiation power of a visible region in a wavelength of 380 to 780 nm and that of an infrared region of a wavelength of 780 to 1200 nm is 2.0:1 to 3.2:1 while the lamp is stably lit.

This aspect of the present invention specifies a preferable radiation power ratio between the visible region and a near-infrared region of a wavelength of 780 to 1200 nm. That is, with the above-specified radiation power ratio, the visible light satisfies the specification as a metal halide lamp for a vehicle headlight and at the same time, a sufficient luminous flux of near-infrared light can be obtained to serve as a light source for an infrared night imaging vision apparatus for achieving a longer range of visibility than required in night imaging vision. It should be noted that a more preferable result can be obtained if the radiation power ratio is in a range of 2.5:1 to 2.9:1.

Here, if the radiation power ratio is less than 2.0, the radiation power of the near-infrared light becomes higher and therefore the range of visibility by the infrared light becomes longer. Instead, the radiation power of the visible light becomes lower and the total luminous flux utilized as the light source for the vehicle headlight becomes excessively small, which cannot satisfy the specification. On the other hand, if the radiation power ratio exceeds 3.2, the radiation power of the visible light becomes higher and the total luminous flux utilized as the light source for the vehicle headlight becomes large. Instead, the radiation power of the near-infrared light becomes lower and therefore the range of visibility by the infrared light becomes excessively short.

According to the third aspect of the present invention, there is provided a metal halide lamp used for a vehicle headlight that is similar to the metal halide lamp of the first or second aspect, character-ized in that a ratio between a radiation power of a near-infrared region in a wavelength of 780 to 800 nm and that of an infrared region of a wavelength of 780 to 1000 nm is 0.1:1 to 0.33:1 while the lamp is stably lit.

This aspect of the present invention specifies, especially for the infrared night imaging vision apparatus, even a further effective radiation power ratio in the near-infrared light wavelength region. That is, a wavelength of 780 to 800 is a region where the sensitivity is remarkably high in the sensitivity characteristics of the camera of the infrared night imaging vision apparatus that is sensitive to near-infrared light. Therefore the ratio of the near-infrared light in this region is within the range of the radiation power ratio specified above, it is possible to shoot a low-light image in a longer range of visibility than normally required with infrared light even by a small radiation power. As a result, it becomes possible to distribute a larger radiation power to the generation of the visible light. It should be noted that a more preferable result can be obtained if the radiation power ratio is in a range of 0.18:1 to 0.26:1.

Here, if the radiation power ratio is less than 0.1, the total luminous flux utilized as the light source for the vehicle headlight becomes excessively large; however, the near-infrared light, which is required for shooting a low-light image by the infrared night imaging vision apparatus becomes weak, thereby making the range of visibility by the infrared light excessively short. On the other hand, if the radiation power ratio exceeds 0.33, the effective near-infrared light is increased and the range of visibility by the infrared light becomes longer. However, the visible light becomes excessively low instead, which cannot satisfy the specification for the metal halide lamp for the vehicle headlight.

According to the fourth aspect of the present invention, there is provided a metal halide lamp used for both a vehicle headlight and an infrared night imaging vision apparatus that is similar to the metal halide lamp of any one of the first to third aspects, characterized in that the metal that emits light mainly in a near-infrared region of a wavelength of 780 to 800 is rubidium (Rb).

This aspect of the present invention specifies an appropriate element as the metal contained in the second halide and emitting light mainly in a near-infrared region of a wavelength of 780 to 800. That is, as described before, rubidium (Rb) emits light prominently in a near-infrared region of a wavelength of 770 to 800, particularly, in a range of 780 to 800 nm. The light emission range substantially matches with a particularly high sensitive region of the sensitivity characteristics of the infrared night imaging vision apparatus. Therefore, with use of a halide of rubidium as the second halide in the present invention, it is possible to achieve a long low-light range of visibility even by a small radiation power of the near-infrared light. Further, as the radiation power of the near-infrared light is smaller, the radiation power distributed to the visible light can be increased accordingly. Therefore, the entire luminous flux can be increased, the above-described specification for the metal halide lamp for the vehicle headlight can be easily satisfied. Further, with use of a halide of rubidium as the second halide, it is possible to satisfy the conditions for the metal halide lamp used for both a vehicle headlight and an infrared night imaging vision apparatus of the second and third aspects of the present invention.

According to the fifth aspect of the present invention, there is provided a metal halide lamp used for both a vehicle headlight and an infrared night imaging vision apparatus that is similar to the metal halide lamp of the fourth aspect, characterized in that an amount of a halide of rubidium (Rb) is 0.2 to 8 mg per internal volume of 1 cc of the hermetic vessel.

This aspect of the present invention specifies an appropriate amount of rubidium (Rb) sealed in as the second halide. That is, within the above-described range, the total luminous flux can satisfy the specification for the metal halide lamp for the vehicle headlight. Further, when the vehicle headlight is used in the low beam mode, an obstacle that is located in a far distance that can not be covered by the light, can be viewed with infrared light by the infrared night imaging vision apparatus.

Here, if the amount of the halide of rubidium (Rb) sealed is less than 0.2 mg per internal volume of 1 cc of the hermetic vessel, the radiation power of the near-infrared light becomes excessively low and therefore the range of visibility with infrared light by the infrared night imaging vision apparatus becomes short. On the other hand, if the amount of the halide of rubidium (Rb) sealed exceeds 8 mg, the radiation power of the visible light becomes excessively low and the total luminous flux cannot satisfy the specification for the metal halide lamp for the vehicle headlight.

According to the sixth aspect of the present invention, there is provided a metal halide lamp used for both of a vehicle headlight and an infrared night imaging vision apparatus, comprising: a refractory and light-transmitting hermetic vessel; a pair of electrodes sealed in the hermetic vessel; and substantially mercury-free discharge medium sealed in the hermetic vessel and including a first metal halide containing at least one of sodium (Na), scandium (Sc) and a rare earth metal, a second halide of a metal which emits light mainly in a near-infrared region of a wavelength of 840 to 930 nm, and a gas which emits light mainly in a near-infrared region of a wavelength of 820 to 1000 nm, wherein the visible light is used for the vehicle headlight and the near-infrared light is used for the infrared night imaging vision apparatus at the same time.

This aspect of the present invention is characterized in that the second halide contains a metal which emits light mainly in a near-infrared region of a wavelength of 840 to 930 nm, and the visible light is used for the vehicle headlight and the near-infrared light is used for the infrared night imaging vision apparatus at the same time, as compared to the metal halide lamp of the first aspect.

More specifically, the near-infrared region of a wavelength of 840 to 930 nm is slightly drifted from the peak wavelength of the sensitivity characteristics of the infrared camera of the vehicle night imaging vision apparatus; however it is still in a sufficiently high sensitive region. Therefore, even with a relatively small radiation power, a low-light image can be shot with infrared light. It should be noted that the expression “emitting light mainly in a near-infrared wavelength range” is used to mean such a concept that includes cases where a wavelength region that has the maximum radiation energy is present in the near-infrared region and a wavelength region that has an effective radiation energy that can surely contribute to an infrared night imaging vision apparatus is present in the near-infrared region, regardless of whether the spectrum of the emitted light is of an emission line spectrum or continuous spectrum, as in the case of the metal halide lamp of the first aspect. Further, the above-mentioned wavelength region can be obtained easily with use of, for example, a halide of cesium (Cs).

Further, in this aspect of the present invention, the visible light is generated mainly from the vapor of the metal that constitutes the first halide when it is exposed to electrical discharge. The near-infrared light is generated mainly from the vapor of the metal that constitutes the second halide and the gas, when they are exposed to electrical discharge. The visible light and near-infrared light are utilized at the same time. That is, the visible light is used for the vehicle headlight, whereas at the same time, the near-infrared light is used for the infrared night imaging vision apparatus.

The hermetic vessel, the pair of electrodes, the first halide, the gas and mercury of the discharge medium are similar to those explained in connection with the metal halide lamp used for both of the vehicle headlight and infrared night imaging vision apparatus of the first aspect.

According to the seventh aspect of the present invention, there is provided a metal halide lamp used for both a vehicle headlight and an infrared night imaging vision apparatus that is similar to the metal halide lamp of the sixth aspect, characterized in that a ratio between a radiation power of a visible region in a wavelength of 380 to 780 nm and that of a near-infrared region of a wavelength of 800 to 1200 nm is 1.8:1 to 3.1:1 while the lamp is stably lit.

This aspect of the present invention specifies a preferable radiation power ratio between the visible region and a near-infrared region of a wavelength of 800 to 1200 nm. That is, with the above-specified radiation power ratio, the visible light satisfies the specification as a metal halide lamp for a vehicle headlight and at the same time, a sufficient luminous flux of near-infrared light can be obtained to serve as a light source for an infrared night imaging vision apparatus for achieving a longer range of visibility than required in night imaging vision. It should be noted that a more preferable result can be obtained if the radiation power ratio is in a range of 2.2:1 to 2.7:1. Therefore, this aspect of the invention is suitable for the case where the visible light is used for the vehicle headlight, whereas at the same time, the near-infrared light is used for the infrared night imaging vision apparatus.

Here, if the radiation power ratio is less than 1.8, the radiation power of the near-infrared light becomes higher and therefore the range of visibility by the infrared light becomes longer. Instead, the radiation power of the visible light becomes lower and the total luminous flux utilized as the light source for the vehicle headlight becomes excessively small, which cannot satisfy the specification of the metal halide lamp for the vehicle headlight. On the other hand, if the radiation power ratio exceeds 3.1, the radiation power of the visible light becomes higher and the total luminous flux utilized as the light source for the vehicle headlight becomes large. Instead, the radiation power of the near-infrared light becomes lower and therefore the range of visibility by the infrared light becomes excessively short.

According to the eighth aspect of the present invention, there is provided a metal halide lamp used for both a vehicle headlight and an infrared night imaging vision apparatus that is similar to the metal halide lamp of the sixth or seventh aspect, characterized in that the metal that emits light mainly in a near-infrared region of a wavelength of 840 to 930 is cesium (Cs).

This aspect of the present invention specifies an appropriate element as the metal contained in the second halide and emitting light mainly in a near-infrared region of a wavelength of 840 to 930 nm. That is, cesium (Cs) has light emission lines at wavelengths of 760.9, 801.5, 807.9, 852.1, 876.1, 894.3, 920.8, 917.2, 1002.0 and 1012.0 nm, and it emits light prominently in a region of a wavelength of 840 to 930 nm. The light emission range substantially matches with a particularly high sensitive region of the sensitivity characteristics of the infrared night imaging vision apparatus. Therefore, with use of a halide of cesium as the second halide in the present invention, it is possible to achieve a long low-light range of visibility even by a small radiation power of the near-infrared light. Further, as the radiation power of the near-infrared light is smaller, the radiation power distributed to the visible light can be increased accordingly. Therefore, the total luminous flux can be increased, the above-described specification for the metal halide lamp for the vehicle headlight can be easily satisfied. Further, with use of cesium as the metal contained in the second halide, it is possible to satisfy the conditions for the metal halide lamp used for both a vehicle headlight and an infrared night imaging vision apparatus of the seventh and eighth aspects of the present invention.

According to the ninth aspect of the present invention, there is provided a metal halide lamp used for both a vehicle headlight and an infrared night imaging vision apparatus that is similar to the metal halide lamp of the eighth aspect, characterized in that an amount of a halide of cesium (Cs) is 0.2 to 10 mg per internal volume of 1 cc of the hermetic vessel.

This aspect of the present invention specifies an appropriate amount of cesium (Cs) sealed in as the second halide. That is, within the above-described range, the total luminous flux can satisfy the specification for the metal halide lamp for the vehicle headlight. Further, when the vehicle headlight is used in the low beam mode, an obstacle that is located in a far distance that can not be covered by the light, can be viewed with infrared light by the infrared night imaging vision apparatus.

Here, if the amount of the halide of rubidium (Rb) sealed is less than 0.2 mg per internal volume of 1 cc of the hermetic vessel, the radiation power of the near-infrared light becomes excessively low and therefore the range of visibility with infrared light by the infrared night imaging vision apparatus becomes short. On the other hand, if the amount of the halide of cesium sealed exceeds 10 mg, the radiation power of the visible light becomes excessively low and the total luminous flux cannot satisfy the specification for the metal halide lamp for the vehicle headlight.

According to the tenth aspect of the present invention, there is provided a metal halide lamp used for both a vehicle headlight and an infrared night imaging vision apparatus that is similar to the metal halide lamp of any one of the first to ninth aspects, characterized in that the discharge medium contains the third halide having a relatively high vapor pressure and being a halide of at least one kind of metal that emits a visible light less than that emitted by the metal of the first halide.

This aspect of the present invention specifies such a structure that the discharge medium contains the third halide in addition to the first and second halides. That is, the third halide has a relatively high vapor pressure of the metal contained therein, and therefore it contributes to the generation of the lamp voltage of the metal halide lamp in place of mercury. Therefore, even without sealing mercury, the lamp voltage can be increased. Thus, for inputting the same lamp power, the lamp current can be effectively reduced. The metals that satisfy this condition are, for example, magnesium (Mg), iron (Fe), cobalt (Co), chromium (Cr), zinc (Zn), nickel (Ni), manganese (Mn), aluminum (Al), antimony (Sb), beryllium (Be), rhenium (Re), gallium (Ga), titanium (Ti), zirconium (Zr), hafnium (Hf) and tin (Sn). For the metal contained in the third halide, one of the above-listed group or two or more of these can be used.

According to the eleventh aspect of the present invention, there is provided a metal halide lamp used for both a vehicle headlight and an infrared night imaging vision apparatus that is similar to the metal halide lamp of any one of the first to tenth aspects, characterized in that the first halide contains halides of sodium (Na) and scandium (Sc) as its main contents.

This aspect of the present invention specifies a preferable structure of the first halide that is suitable for the light source of the vehicle headlight. With the specified structure, the white light that can satisfy the specification for the metal halide lamp for the vehicle headlight can be generated at a high efficiency. It should be noted that the first halide is allowed to contain only the two types of metals described above or to contain a rare earth metal as a supplemental element added thereto as needed.

According to the twelfth aspect of the present invention, there is provided a metal halide lamp used for both a vehicle headlight and an infrared night imaging vision apparatus that is similar to the metal halide lamp of any one of the first to eleventh aspects, characterized in that the gas that emits light mainly in a near-infrared region of a wavelength of 820 to 1000 is xenon (Xe).

This aspect of the present invention specifies a preferable type of gas that emits light mainly in a near-infrared region of a wavelength of 820 to 1000 nm. That is, xenon (Xe) has light emission lines at wavelengths of 823.1, 881.9, 895.2, 904.5, 916.2, 937.4, 951.3, 979.9 and 992.3 nm in a region of a wavelength of 820 to 1000 nm. The xenon gas generates the near-infrared light suitable for the light source for the CCD camera of the infrared night imaging vision apparatus, that is sensitive to the near-infrared light when the gas is exposed to electrical discharge. Further, immediately after the starting of the metal halide lamp, that is, when the generation of the visible light by the metal contained in the first halide is not yet sufficient, the white light is generated. Therefore, the generated light can satisfy the specification for the metal halide lamp for the vehicle headlight even immediately after the starting of the lamp, and the rise of the light of the desired color is quick.

According to the thirteenth aspect of the present invention, there is provided a metal halide lamp used for both a vehicle headlight and an infrared night imaging vision apparatus that is similar to the metal halide lamp of the twelfth aspect, characterized in that a pressure for sealing xenon (Xe) is 6 atmospheres or higher.

This aspect of the present invention specifies a preferable sealing pressure for xenon (Xe). That is, in the case of a metal halide lamp without mercury sealed therein, xenon functions as a buffer gas to maintain the heat of the plasma in place of mercury. Therefore, when the sealing pressure of the gas is increased, the heat loss of the metal halide lamp is decreased and the total luminous flux is increased. Further, at the same time, the emission of the near-infrared light of a wavelength of 820 to 1000 nm is increased. If the sealing pressure for xenon is 6 atmospheres or higher, it is possible to establish such a structure that the total luminous flux can satisfy the specification for the metal halide lamp for the vehicle headlight. Furthermore, the emission of the near-infrared light is increased and therefore the range of visibility by the infrared night imaging vision apparatus with infrared light becomes longer. The sealing pressure for xenon (Xe) is of the value taken in terms of room temperature at 25° C.

According to the fourteenth aspect of the present invention, there is provided a metal halide lamp used for both a vehicle headlight and an infrared night imaging vision apparatus that is similar to the metal halide lamp of any one of the first to thirteenth aspects, characterized in that a rated lamp power is in a range of 35±3 W.

This aspect of the present invention specifies such a structure that the metal halide lamp used for both a vehicle headlight and an infrared night imaging vision apparatus has a rated lamp power that meets the specification for the metal halide lamp for the vehicle headlight. That is, with the above-specified range of the rated lamp power, the rated input satisfies the specification for the metal halide lamp for the vehicle headlight. For this range, the power is about one half of that of the light source for the halogen lamp for a vehicle headlight.

According to the fifteenth aspect of the present invention, there is provided a metal halide lamp used for both a vehicle headlight and an infrared night imaging vision apparatus that is similar to the metal halide lamp of any one of the first to fourteenth aspects, characterized in that the lamp is of the D3S or D4S type, and the total luminous flux is 2750 lm or more.

This aspect of the present invention specifies the metal halide lamp to such a type that meets the specifications for the projector 4-light mode and projector 2-light mode of the above-described specifications for the vehicle headlight.

According to the sixteenth aspect of the present invention, there is provided a metal halide lamp used for both a vehicle headlight and an infrared night imaging vision apparatus that is similar to the metal halide lamp of any one of the first to fourteenth aspects, characterized in that the lamp is of the D3R or D4R type, and the total luminous flux is 2350 lm or more.

This aspect of the present invention specifies the metal halide lamp to such a type that meets the specifications for the reflector 4-light mode and reflector 2-light mode of the above-described specifications for the vehicle headlight.

According to the seventeenth aspect of the present invention, there is provided a metal halide lamp used for both a vehicle headlight and an infrared night imaging vision apparatus that is similar to the metal halide lamp of any one of the first to sixth aspects, characterized in that, mainly, a near-infrared light having a wavelength of 760 nm or higher is utilized by the night imaging vision apparatus.

This aspect of the present invention specifies a preferable utilized wavelength range for the infrared night imaging vision apparatus in the case where the second halide contains a halide of a metal that emits light mainly in a near-infrared wavelength region of 780 to 800 nm.

According to the eighteenth aspect of the present invention, there is provided a metal halide lamp used for both a vehicle headlight and an infrared night imaging vision apparatus that is similar to the metal halide lamp of any one of the sixth to ninth aspects, characterized in that, mainly, a near-infrared light having a wavelength of 800 nm or higher is utilized by the night imaging vision apparatus.

This aspect of the present invention specifies a preferable utilized wavelength range for the infrared night imaging vision apparatus in the case where the second halide contains a halide of a metal that emits light mainly in a near-infrared wavelength region of 840 to 930 nm.

According to still another aspect of the present invention, there is provided a metal halide lamp lighting apparatus comprising: a metal halide lamp used for both a vehicle headlight and an infrared night imaging vision apparatus which is similar to the metal halide lamp of any one of the first to eighteenth aspects; and a lighting device configured to urge the metal halide lamp used for both a vehicle headlight and an infrared night imaging vision apparatus.

In the present invention, the term “vehicle headlight main body” is used to mean the entire section of the vehicle headlight except for the portions of metal halide lamp used for both a vehicle headlight and an infrared night imaging vision apparatus and the lighting circuit.

The lighting circuit is a unit that lights the metal halide lamp used for both a vehicle headlight and an infrared night imaging vision apparatus. It is preferable that the circuit should be of an electronic type; however in short, it also may be of a type consisting of a coil and an iron core as its main portion.

In the case of the lighting circuit for the vehicle headlight, the maximum input power up to 4 seconds immediately after the lighting of the metal halide lamp used for both a vehicle headlight and an infrared night imaging vision apparatus is set to 2 to 4 times as much as the lamp power in a stable operation, preferably, 2 to 3 times as much. Thus, it is possible to make the rise of the luminous flux quicker to fall in a range necessary for the vehicle headlight.

Further, when the circuit is constituted to satisfy a mathematical formula: AA>−2.5X+102.5 where X (atmospheric pressure) represents the sealing pressure of xenon (Xe) in a range of 6 to 18 atmospheres as a gas that radiates near-infrared light having a wavelength of 820 to 1000 nm, and AA (watts) represents the maximum input power up to 4 seconds immediately after the lighting of the metal halide lamp. With this structure, it is possible to accelerate the rise of the luminous flux up to 4 seconds immediately after the lighting of the metal halide lamp and to obtain a luminous intensity of 8000 cd at a typical point in front of the headlight, which is required to be achieved by a vehicle headlight. This is because only a discharge medium having a low vapor pressure can achieve a linear relationship between the sealing pressure of xenon and the maximum input power as expressed by the mathematical formula, and at the point of 4 seconds after the start, the light emission of xenon dominates overwhelmingly. The amount of light emission with xenon is determined by the sealing pressure and the electric power at that point. Therefore, if the sealing pressure of xenon is low, the input power should only be increased. On the other hand, if the sealing pressure of xenon is high, the input power should only be decreased. Further, in the present invention, the metal halide lamp used for both a vehicle headlight and an infrared night imaging vision apparatus may be lit by either one of the alternate current or direct current mode.

Furthermore, it is alternatively possible that the lighting circuit is structured such that the no-load output voltage is 200V or less in accordance with necessity. In general, mercury-free metal halide lamps have a lower lamp voltage as compared to mercury-sealed metal halide lamps, and therefore it is possible to set the no-load output voltage of the lighting circuit to 200V or less. As a result, the size of the lighting circuit can be decreased.

### BRIEF DESCRIPTION OF THE SEVERAL VIEWS OF THE DRAWING

FIG. 1 is a graph illustrating characteristic curves of spectral distributions of metal halide lamps containing discharge media of the first and third halides and a gas of ScI₃—NaI—ZnI₂—Xe sealed therein, in one of which RbI is sealed, whereas in the other of which CsI is sealed, as the characteristic curves are superimposed one on another, along with a curve of the sensitivity characteristics of a CCD camera shown in FIG. 5, which will be described later, as it is further superimposed thereon;

FIG. 2 is a graph illustrating a spectral distribution characteristic curve of a lamp in which only xenon is sealed;

FIG. 3 is a graph illustrating characteristic curves of spectral distributions of a metal halide lamp containing discharge media of the first and third halides and a gas of ScI₃—NaI—ZnI₂—Xe sealed therein, in which the Xe light emission is estimated;

FIG. 4 is a conceptual figure that illustrates the operation principle of the active type infrared night imaging vision apparatus;

FIG. 5 is a graph that illustrates a spectral sensitivity characteristic curve of a CCD camera used for the infrared night imaging vision apparatus;

FIG. 6 is a front view of the entire lamp of the D4S type, as the first aspect of the metal halide lamp used for both a vehicle headlight and an infrared night imaging vision apparatus of the present invention;

FIG. 7 is a plan view of the entire lamp of the D4S type, as the first aspect of the metal halide lamp used for both a vehicle headlight and an infrared night imaging vision apparatus of the present invention;

FIG. 8 is a graph illustrating characteristic curves of spectral distributions of a lamp L according to Embodiment 1 of the present invention;

FIG. 9 is a graph illustrating characteristic curves of spectral distributions of a lamp L according to Embodiment 2 of the present invention; and

FIG. 10 is a circuit diagram illustrating an example of a metal halide lamp lighting apparatus according to the present invention.

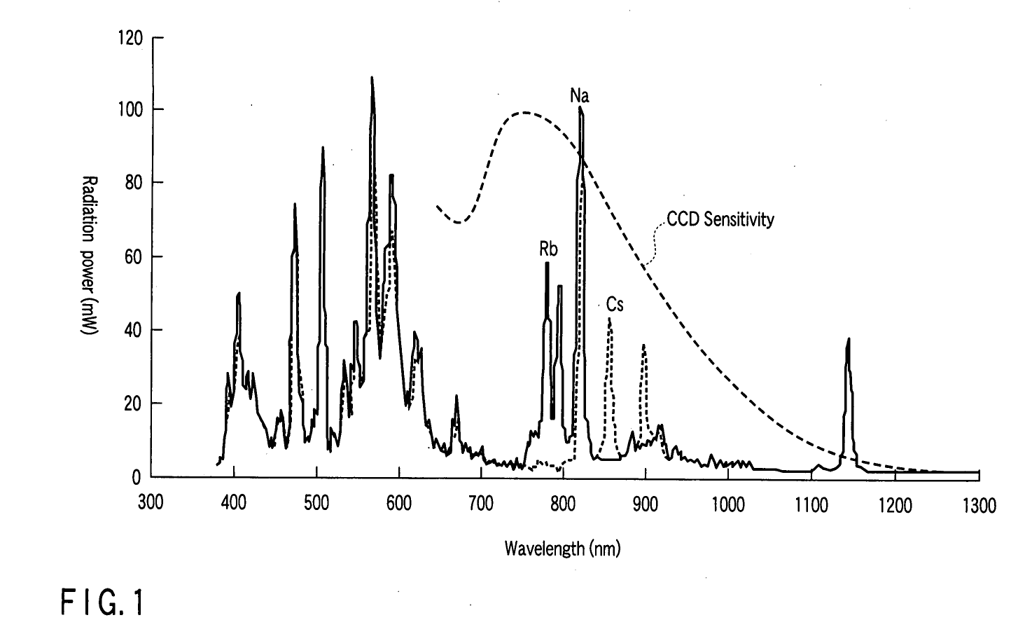

### DETAILED DESCRIPTION OF THE INVENTION

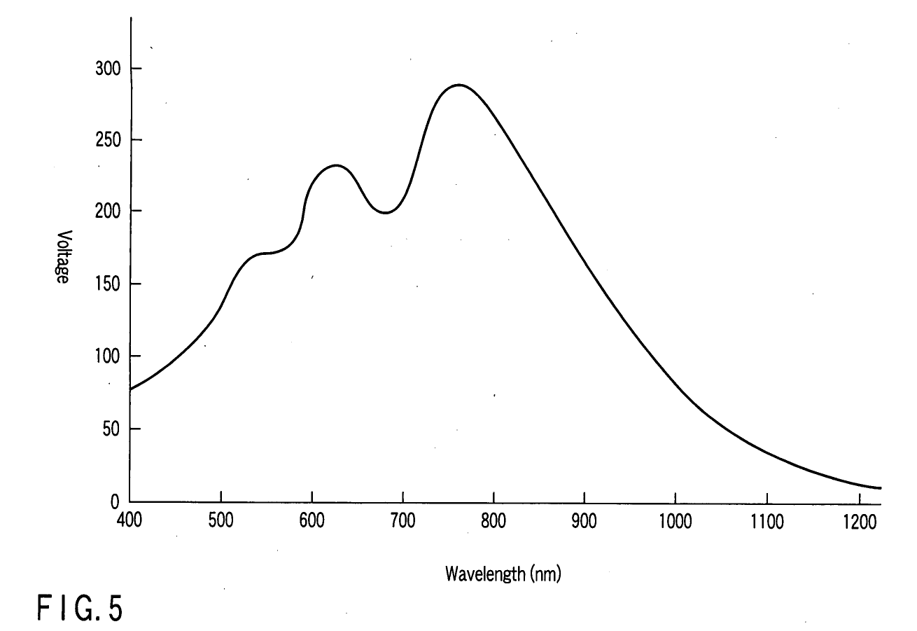

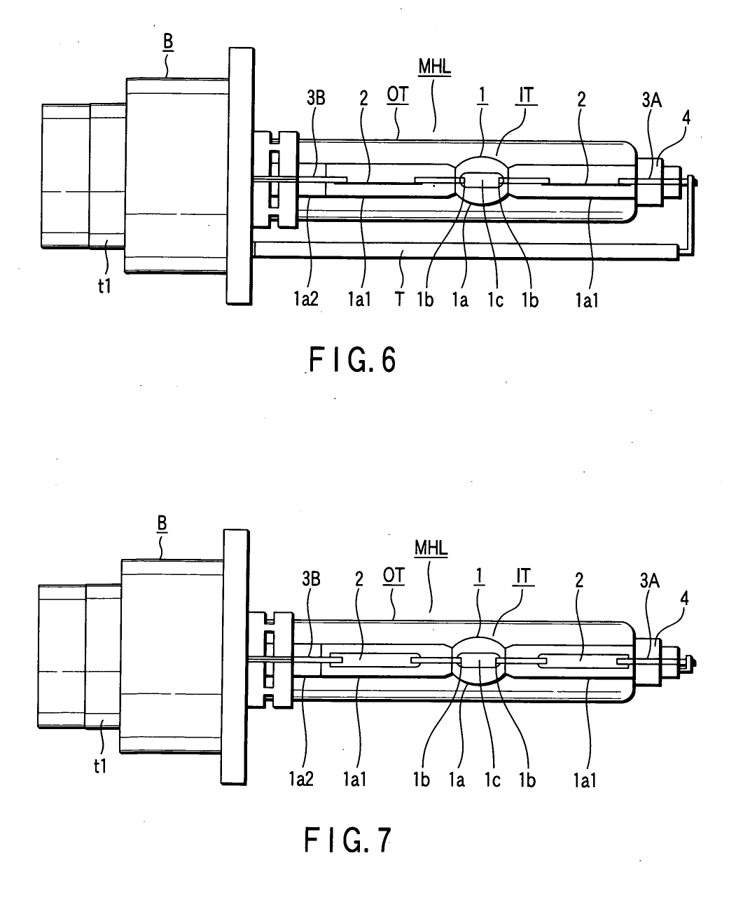

FIGS. 6 and 7 shows the first aspect that embodies the metal halide lamp used for both a vehicle headlight and an infrared night imaging vision apparatus of the present invention. FIG. 5 is a front view of the entire lamp of the D4S type, and FIG. 7 is a plan view of the same entire lamp. The metal halide lamp HML used for both a vehicle headlight and an infrared night imaging vision apparatus, includes a light-emitting tube IT, an insulating tube T, an outer tube OT and a base B.

The light-emitting tube IT includes an hermetic vessel 1, a pair of electrodes 1b and 1b, sealed metal foils 2, a pair of outer lead wires 3A and 3B The hermetic vessel 1 includes an enclosure portion 1a and a pair of sealing sections 1a1. The enclosure portion 1a is formed to have a hollow spindle shape, and the pair of long and narrow sealing sections 1a1 are integrally formed at both ends of the enclosure. Further, inside the enclosure, a long and narrow and substantially cylindrical discharge space 1c is formed. The volume of the discharge space 1c is 0.05 cc or less.

Each electrode 1b is made of a pure tungsten wire, and the axial portion thereof has the same diameter at its axial distal end portion, the middle portion and the proximal end portion in its axial direction. Further, the distal end portion and a part of the middle portion are exposed in the discharge space 1c. Meanwhile, the proximal portion of each electrode 1b is welded to the respective one of the sealed metal foils 2 buried in the sealing sections 1a1. Further, the middle portion is softly supported by the sealing portions 1a1 and thus it is placed at a predetermined position in the hermetic vessel 1.

In each figure, the left-hand side sealing portion 1a1 is formed, and after that, the sealing tube 1a2 is extended integrally from the lower portion of the sealing portion 1a1 without being disconnected, into the base B.

The sealed metal foils 2 are made of molybdenum foils and airtightly buried in the respective sealing portions 1a1 of the hermetic vessel 1.

The discharge medium contains the first to third halides and the gas. The first halide includes at lease one of sodium (Na), scandium (Sc) and an rare earth metal. The second halide contains a halide of a metal that emits light mainly in a near-infrared wavelength range of 840 to 930 mm. The third halide has a relatively high vapor pressure and contains a halide of at least one kind of metal that emits a visible light less than that emitted by the metal of the first halide. The gas is a rare gas.

The pair of outer lead wires 3A and 3B have distal ends, which are welded to the other respective ends of the sealed metal foils 2 in the sealing portions 1a1 at both ends of the hermetic vessel 1, and proximal ends that are guided to the outside. In each of these figures, the outer lead wire 3A guided out to the right-hand side from the discharge container IT is folded at its middle portion along the outer tube OT, which will be later described, and then guided into the base B, which will be also later described. Then, the lead wire is connected to one of base terminals t1 that is formed into a ring provided around the outer circumferential surface of the base B. As shown in FIG. 6, the outer lead wire 3B guided out to the left-hand side from the discharge vessel IT is extended along the axis of the tube and guided into the base B. Then, the lead wire is connected to the other one of base terminals t1 that is formed into a pin shape provided at the center, though it is not shown in the figure.

In the inner space 1c of the enclosure portion 1a of the hermetic vessel 1, the discharge medium is sealed. The discharge medium contains the first to third halides and the gas, but substantially no mercury. The first halide includes at least one of sodium (Na), scandium (Sc) and an rare earth metal. The second halide contains a halide of a metal that emits light mainly in a near-infrared wavelength range of 780 to 800 mm. The third halide has a relatively high vapor pressure and contains a halide of at least one kind of metal that emits a visible light less than that emitted by the metal of the first halide. The gas is a rare gas.

The outer tube OT has an ultraviolet line cut property, and houses the discharge container IT inside. Small diameter portions 4 of both ends of the tube (only one end at the right-hand side is shown in the figure) are glass-welded to the sealing portions 1a1 of the discharge vessel IT. However, the inside of the outer tube OT is not airtight but communicated to the outside.

The insulating tube T is made of a ceramic tube, and covers the outer lead wire 3A.

The base B is of a type standardized for a vehicle headlight, and supports the discharge vessel IT and outer tube OT to be implanted and set straight along the central axis. The case b is detachably mounted in the rear surface of the vehicle headlight. Further, the base B includes one of base terminals t1 that is formed into a ring provided around the outer circumferential surface of the base B, so that it can be connected to the lamp socket of the power source side when the base is mounted, and the other one of base terminals t1 that is formed into a pin shape projecting in the axial direction at the center in a recess portion formed inside the cylindrical portion, whose one end is opened.

### Embodiment 1

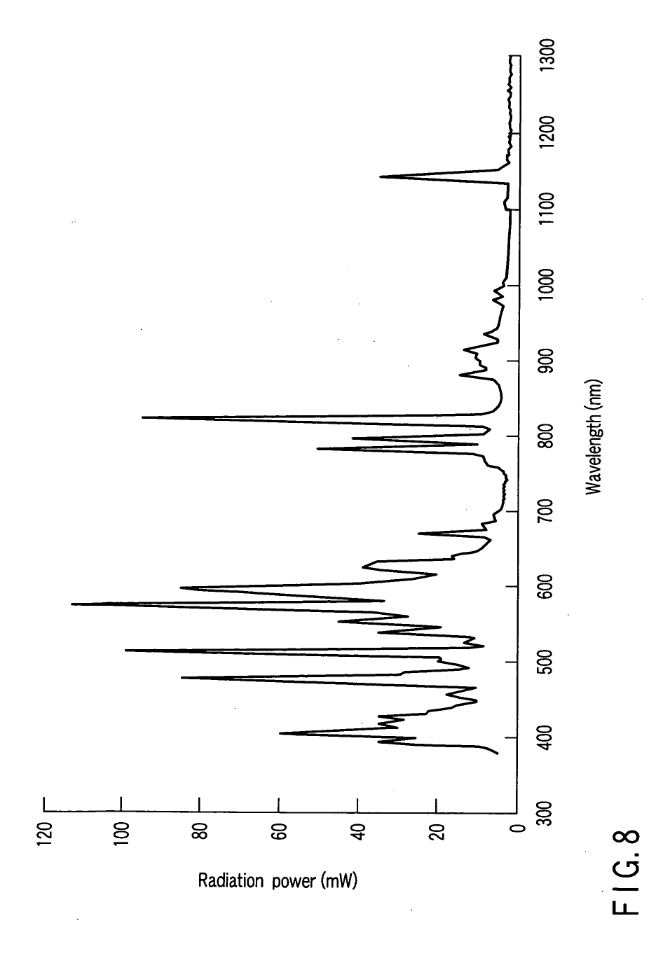

The first embodiment shown in FIGS. 6 and 8, that embodies the metal halide lamp used for both a vehicle headlight and an infrared night imaging vision apparatus of the present invention will now be described. The specifications of this embodiment are as follows.

Discharge Vessel IT

Hermetic vessel 1a: made of quartz glass, length of spherical portion of 7 mm, a maximum outer diameter 6 mm, a total length of about 50 mm, a maximum inner diameter of 2.6 mm and an internal volume of 0.025 cc

Electrodes 1b: made of a tungsten wire having a diameter of 0.35 mm, and a distance between the electrodes being 4.2 mm

Discharge Medium

The first halide: NaI—ScI₃, as to the sealing amounts, see TABLE 1.

The second halide: RbI, as to the sealing amount, see TABLE 1.

The third halide: ZnI₂, as to the sealing amount, see TABLE 1.

The gas: xenon (Xe), as to the sealing pressure, see TABLE 1.

The outer tube OT: an outer diameter of 9 mm, an inner diameter of 7 mm, an internal atmosphere; atmospheric pressure (atmosphere)

Input power immediately after lighting: 85 W

Rated lamp power: 35 W

FIG. 8 is a graph illustrating characteristic curves of spectral distributions of a lamp L according to Embodiment 1 of the present invention. As can be understood from this figure, in this embodiment, the near-infrared region is mainly constituted by the light emission of rubidium (Rb) at a wavelength of 780 to 800 nm, the light emission of sodium (Na) at a wavelength of 819 nm, and the light emission of xenon (xe) at a wavelength of 880 to 1000 nm.

TABLE 1

| | | Xe | | | | |
|---|---|---|---|---|---|---|
| | Hg | (atmospheric | ZnI₂ | NaI | ScI₃ | RbI |
| Lamp | (mg) | pressure) | (mg) | (mg) | (mg) | (mg) |
| A | 0.5 | 6 | — | 0.26 | 0.13 | — |
| B | — | 6 | 0.2 | 0.26 | 0.13 | — |
| C | — | 9 | 0.2 | 0.26 | 0.13 | — |
| D | — | 13 | 0.2 | 0.26 | 0.13 | — |
| E | — | 6 | 0.2 | 0.26 | 0.13 | 0.005 |
| F | — | 10 | 0.2 | 0.26 | 0.13 | 0.005 |
| G | — | 10 | 0.2 | 0.26 | 0.13 | 0.01 |
| H | — | 10 | 0.2 | 0.26 | 0.13 | 0.015 |
| I | — | 10 | 0.2 | 0.26 | 0.13 | 0.02 |
| J | — | 10 | 0.2 | 0.26 | 0.13 | 0.025 |
| K | — | 10 | 0.2 | 0.26 | 0.13 | 0.03 |
| L | — | 10 | 0.2 | 0.26 | 0.13 | 0.035 |
| M | — | 10 | 0.2 | 0.26 | 0.13 | 0.04 |
| N | — | 10 | 0.2 | 0.26 | 0.13 | 0.05 |
| O | — | 10 | 0.2 | 0.26 | 0.13 | 0.06 |
| P | — | 10 | 0.2 | 0.26 | 0.13 | 0.08 |
| Q | — | 10 | 0.2 | 0.26 | 0.13 | 0.1 |
| R | — | 10 | 0.2 | 0.26 | 0.13 | 0.15 |
| S | — | 10 | 0.2 | 0.26 | 0.13 | 0.2 |
| T | — | 10 | 0.2 | 0.26 | 0.13 | 0.25 |
| U | — | 10 | 0.2 | 0.26 | 0.13 | 0.3 |
| V | — | 10 | 0.2 | 0.26 | 0.13 | 0.4 |

It should be noted that in TABLE 1, the lamps A to D are comparative examples, in which the discharge medium does not contain the second halide. Further, in the lamp A, 0.5 mg of mercury is sealed.

Next, the performance of the metal halide lamp used for both of a vehicle headlight and an infrared night imaging vision apparatus according to the first embodiment will now be described. Two lamps were selected from each of Embodiment 1 and the comparative examples and mounted on a vehicle headlight. The lamps were lit at a rated lamp power of 35 W when operating stably, and the performance indexes including a radiation power ratio A, radiation power ratio B, total luminous flux (lm) and range of visibility with infrared light (m) were measured. It should be noted that the vehicle headlight used here was of a type equipped with the function of separation light emission by which visible light is irradiated in the low beam direction and infrared light of a wavelength of 780 nm or higher is irradiated in the high beam direction while absorbing visible light. The infrared night imaging vision apparatus equipped with the CCD camera, for shooting, receives reflection light from a distant obstacle generated as the infrared light irradiated from the headlight hits the obstacle, and visualizes the reflection light. The range of visibility in the infrared light was obtained by the following experiment. The lamps of the same type were mounted on the right and left headlights of the vehicle and the range of visibility for a pedestrian walking in a completely dark environment at night was measured. More specifically, in the experiment, the pedestrian walked from a short distance to a far distance. During the process, the maximum distance where the pedestrian can be visually recognized was measured for several persons, and the average of the values for these persons was taken as the infrared range of visibility. The results were summarized in TABLE 2. It should be noted that in TABLE 2, the lamps A to V are the same as those listed respectively in TABLE 1. The radiation power ratio A can be expressed by (radiation power of a visible light region having a wavelength of 380 to 780 nm)/(radiation power of a near infrared light region having a wavelength of 780 to 1200 nm). The radiation power ratio B can be expressed by (radiation power of a visible light region having a wavelength of 780 to 800 nm)/(radiation power of a near infrared light region having a wavelength of 780 to 1000 nm).

TABLE 2

| | | | Total | Infrared |
|---|---|---|---|---|
| | Radiation | Radiation | luminous | range of |
| | power | power | flux | visibility |
| Lamp | ratio A | ratio B | (lm) | (m) |
| A | 5.51 | 0.06 | 3510 | 52 |
| B | 5.02 | 0.05 | 3120 | 60 |
| C | 3.45 | 0.04 | 3330 | 65 |
| D | 3.35 | 0.03 | 3420 | 67 |
| E | 3.2 | 0.12 | 3220 | 82 |
| F | 3.1 | 0.11 | 3180 | 85 |
| G | 3.01 | 0.15 | 3150 | 90 |
| H | 2.9 | 0.18 | 3130 | 102 |
| I | 2.84 | 0.19 | 3120 | 113 |
| J | 2.8 | 0.2 | 3100 | 119 |
| K | 2.75 | 0.21 | 3080 | 126 |
| L | 2.71 | 0.23 | 3050 | 130 |
| M | 2.61 | 0.24 | 3030 | 134 |
| N | 2.52 | 0.26 | 3010 | 139 |
| O | 2.41 | 0.27 | 2950 | 145 |
| P | 2.32 | 0.28 | 2900 | 150 |
| Q | 2.2 | 0.29 | 2860 | 156 |
| R | 2.14 | 0.3 | 2830 | 158 |
| S | 2.1 | 0.33 | 2800 | 160 |
| T | 1.82 | 0.41 | 2650 | 170 |
| U | 1.59 | 0.45 | 2530 | 180 |
| V | 1.41 | 0.48 | 2360 | 200 |

The following facts were found from this experiment.

That is, the total luminous flux of the visible light region and the radiation power of the near-infrared light region, in other words, the infrared range of visibility have such a tendency that they conflict with each other. More specifically, when the radiation power of the near-infrared light region increases and accordingly the infrared range of visibility with the infrared night imaging vision apparatus is increased, the radiation power of the visible light region is decreased and the total luminous flux of the lamp is decreased.

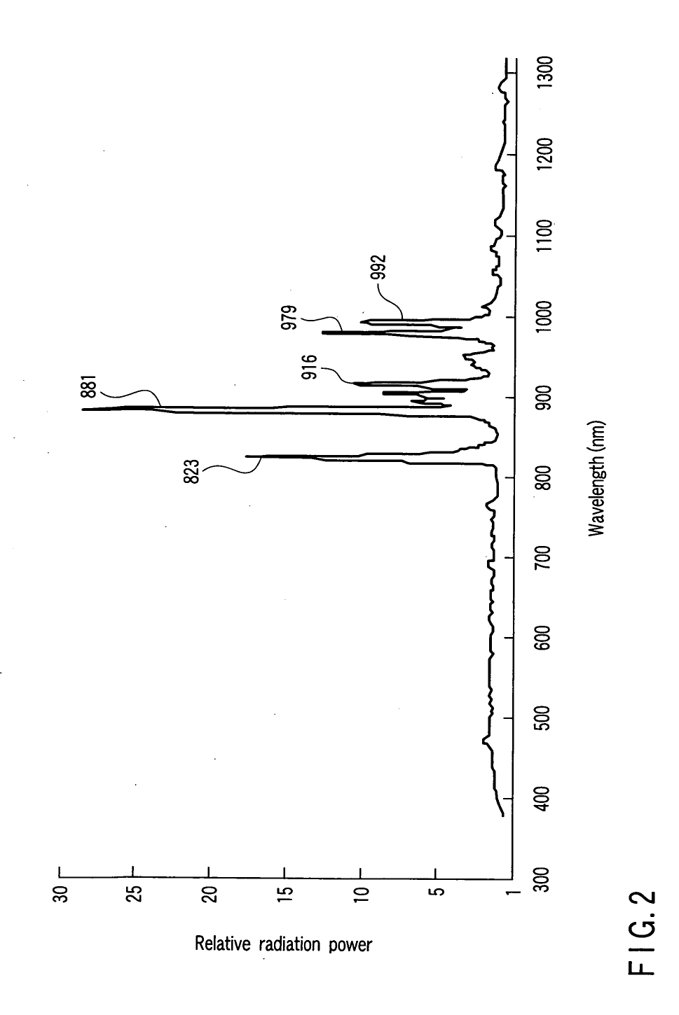

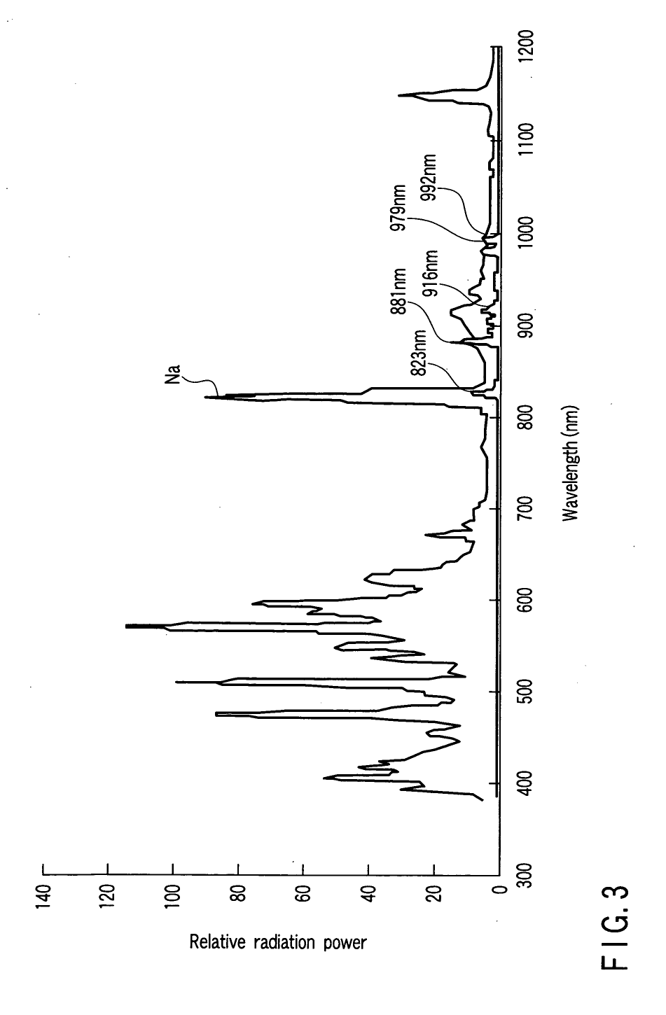

Here, let us focus on the radiation power ratio A as an index indicating the above-described conflicting tendency. In FIG. 2, both of a total luminous flux of 2750 lm (which is the lower limit of the specification for the D4S type) or more, and an infrared range of visibility of 80 m or more can be satisfied when the radiation power ratio A is in a range of 3.2 to 2.1. In other words, this range of the radiation power ratio A indicates an appropriate range in which the infrared range of visibility can be made as large as possible within the specified range of the total luminous flux at a constant rated input of 35 W.

Further, apart from the radiation power ratio A, let us focus here on the radiation power ratio B as an index where the sensitivity characteristics of the CCD image pickup device shown in FIG. 5 were considered. The sensitivity of the CCD camera, in a wavelength range of 780 nm or more, decreases as the wavelength becomes longer. Therefore, the radiation power ratio B is a value obtained by dividing the radiation power in a range of 780 to 800 nm in wavelength with the radiation power in a range of 780 to 1000 nm. This is a ratio of the radiation power in a near-infrared region of 780 to 800 nm in wavelength, where the sensitivity of the CCD camera is high, with respect to the radiation power of the main near-infrared region (780 to 1000 nm). From the results of the experiment summarized in FIG. 2, it is understood that when the radiation power ratio B is in a range of 0.12 to 0.33, a total luminous flux of 2750 lm (, which is the lower limit value of the specification for the D4S type) or more and an infrared range of visibility of 80 m or more are both satisfied. If the radiation power ratio B is 0.33 or higher, the radiation of the visible light is affected. Specifically, a large infrared range of visibility can be obtained, but the total luminous flux falls out of the range defined by the specification.

Next, the second embodiment of the metal halide lamp used for both a vehicle headlight and an infrared night imaging vision apparatus of the present invention will now be described. This embodiment is similar to the first embodiment shown in FIGS. 6 and 7 in the structure of the lamp, but the structure of the discharge medium is different from that of the second embodiment. More specifically, the second halide contains a halide of a metal that emits light mainly in a near-infrared region of 840 to 930 nm in wavelength. The rest of the structure is the same as that of the first embodiment.

### Embodiment 2

The second embodiment that realizes the metal halide lamp used for both a vehicle headlight and an infrared night imaging vision apparatus of the present invention will now be described. The specifications of this embodiment are as follows. The rest of the structure is the same as that of the first embodiment.

Discharge Medium

The first halide: NaI—ScI₃, as to the sealing amounts, see TABLE 3.

The second halide: CsI, as to the sealing amount, see TABLE 3.

The third halide: ZnI₂, as to the sealing amount, see TABLE 3.

The gas: xenon (Xe), as to the sealing pressure, see TABLE 3.

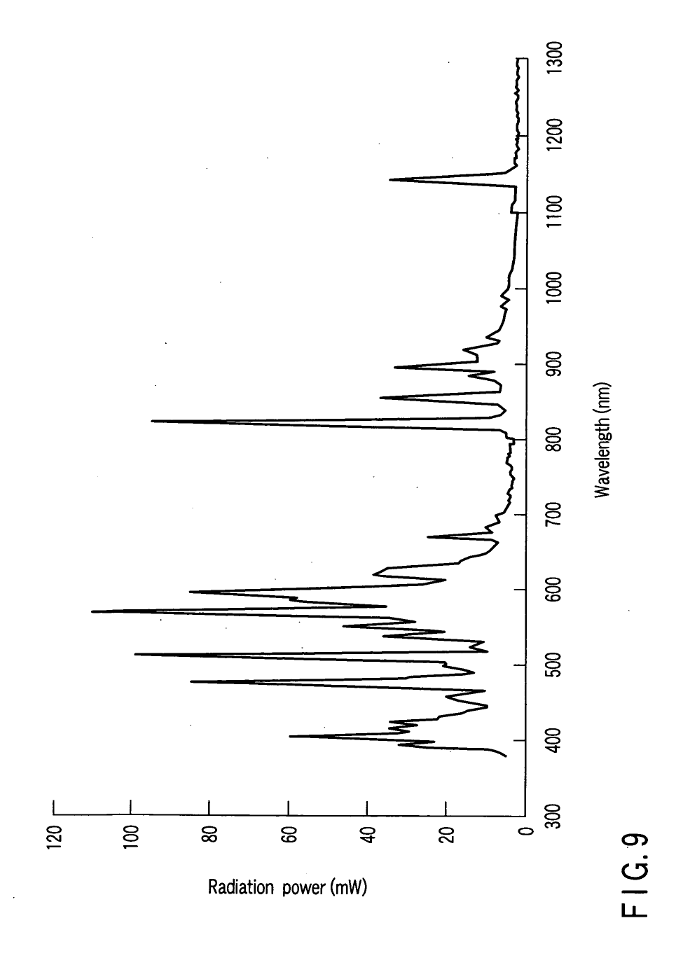

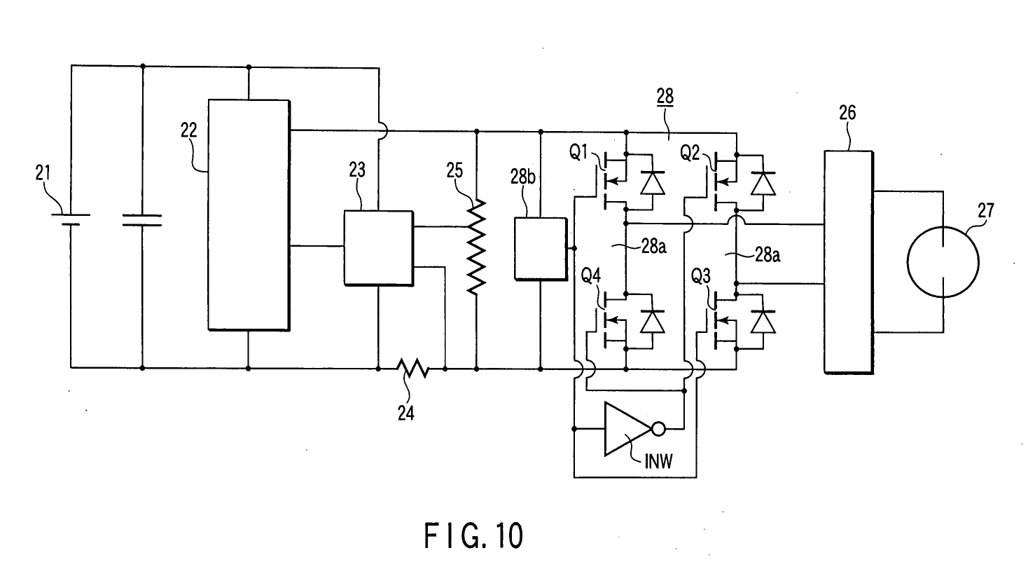

FIG. 9 is a graph illustrating characteristic curves of spectral distributions of a lamp L according to Embodiment 2 of the present invention. As can be understood from this figure, in this embodiment, the near-infrared region is mainly constituted by the light emission of cesium (Cs) at a wavelength of 840 to 930 nm, the light emission of sodium (Na) at a wavelength of 819.4 nm, and the light emission of xenon (xe) at a wavelength of 880 to 1000 nm.

TABLE 3

| | | Xe | | | | |
|---|---|---|---|---|---|---|
| | Hg | (atmospheric | ZnI₂ | NaI | ScI₃ | RbI |
| Lamp | (mg) | pressure) | (mg) | (mg) | (mg) | (mg) |
| A | 0.5 | 6 | — | 0.32 | 0.13 | — |
| B | — | 6 | 0.2 | 0.32 | 0.13 | — |
| C | — | 9 | 0.2 | 0.32 | 0.13 | — |
| D | — | 13 | 0.2 | 0.32 | 0.13 | — |
| E | — | 6 | 0.2 | 0.32 | 0.13 | 0.005 |
| F | — | 10 | 0.2 | 0.32 | 0.13 | 0.005 |
| G | — | 10 | 0.2 | 0.32 | 0.13 | 0.01 |
| H | — | 10 | 0.2 | 0.32 | 0.13 | 0.015 |
| I | — | 10 | 0.2 | 0.32 | 0.13 | 0.02 |
| J | — | 10 | 0.2 | 0.32 | 0.13 | 0.025 |
| K | — | 10 | 0.2 | 0.32 | 0.13 | 0.03 |
| L | — | 10 | 0.2 | 0.32 | 0.13 | 0.035 |
| M | — | 10 | 0.2 | 0.32 | 0.13 | 0.04 |
| N | — | 10 | 0.2 | 0.32 | 0.13 | 0.05 |
| O | — | 10 | 0.2 | 0.32 | 0.13 | 0.06 |
| P | — | 10 | 0.2 | 0.32 | 0.13 | 0.08 |
| Q | — | 10 | 0.2 | 0.32 | 0.13 | 0.1 |
| R | — | 10 | 0.2 | 0.32 | 0.13 | 0.15 |
| S | — | 10 | 0.2 | 0.32 | 0.13 | 0.2 |
| T | — | 10 | 0.2 | 0.32 | 0.13 | 0.25 |
| U | — | 10 | 0.2 | 0.32 | 0.13 | 0.3 |
| V | — | 10 | 0.2 | 0.32 | 0.13 | 0.4 |

It should be noted that in TABLE 3, the lamps A to D are comparative examples, in which the discharge medium does not contain the second halide. Further, in the lamp A, 0.5 mg of mercury is sealed.

Next, the performance of the metal halide lamp used for both of a vehicle headlight and an infrared night imaging vision apparatus according to the second embodiment will now be described. Two lamps were selected from each of Embodiment 1 and the comparative examples and mounted on a vehicle headlight. The lamps were lit at a rated lamp power of 35 W when operating stably, and the performance indexes including a radiation power ratio A, total luminous flux (lm) and range of visibility with infrared light (m) were measured. It should be noted that the vehicle headlight used here was of a type equipped with the function of separation light emission by which visible light is irradiated in the low beam direction and infrared light of a wavelength of 780 nm or higher is irradiated in the high beam direction while absorbing visible light. The infrared night imaging vision apparatus equipped with the CCD camera, for shooting, receives reflection light from a distant obstacle generated as the infrared light irradiated from the headlight hits the obstacle, and visualizes the reflection light. The range of visibility in the infrared light was obtained by the following experiment. The lamps of the same type were mounted on the right and left headlights of the vehicle and the range of visibility for a pedestrian walking in a completely dark environment at night was measured. More specifically, in the experiment, the pedestrian walked from a short distance to a far distance. During the process, the maximum distance where the pedestrian can be visually recognized was measured for several persons, and the average of the values for these persons was taken as the infrared range of visibility. The results were summarized in TABLE 4. It should be noted that in TABLE 4, the lamps A to V are the same as those listed respectively in TABLE 3. The radiation power ratio A can be expressed by (radiation power of a visible light region having a wavelength of 380 to 780 nm)/(radiation power of a near infrared light region having a wavelength of 780 to 1200 nm).

TABLE 4

| | | Total | Infrared |
|---|---|---|---|
| | Radiation | luminous | range of |
| | power | flux | visibility |
| Lamp | ratio A | (lm) | (m) |
| A | 5.81 | 3510 | 52 |
| B | 5.34 | 3120 | 60 |
| C | 3.65 | 3330 | 65 |
| D | 3.53 | 3420 | 67 |
| E | 3.1 | 3260 | 80 |
| F | 3 | 3230 | 83 |
| G | 2.85 | 3210 | 88 |
| H | 2.75 | 3180 | 96 |
| I | 2.69 | 3160 | 110 |
| J | 2.66 | 3140 | 116 |
| K | 2.61 | 3120 | 120 |
| L | 2.6 | 3100 | 126 |
| M | 2.48 | 3080 | 130 |
| N | 2.39 | 3060 | 135 |
| O | 2.27 | 3000 | 140 |
| P | 2.18 | 2950 | 145 |
| Q | 2.09 | 2910 | 150 |
| R | 2.03 | 2880 | 153 |
| S | 1.9 | 2850 | 155 |
| T | 1.8 | 2760 | 164 |
| U | 1.52 | 2550 | 175 |
| V | 1.33 | 2410 | 195 |

The following facts were found from this experiment.

That is, as in the case of the first embodiment, the total luminous flux of the visible light region and the radiation power of the near-infrared light region, in other words, the infrared range of visibility have such a tendency that they conflict with each other. More specifically, when the radiation power of the near-infrared light region increases and accordingly the infrared range of visibility with the infrared night imaging vision apparatus is increased, the radiation power of the visible light region is decreased and the total luminous flux of the lamp is decreased.

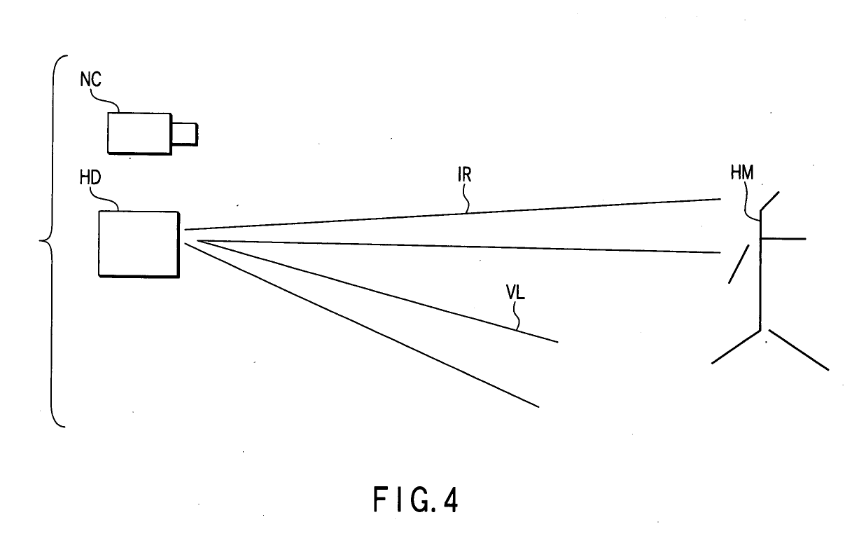

Here, let us focus on the radiation power ratio A as an index indicating the above-described conflicting tendency. In FIG. 4, both of a total luminous flux of 2750 lm (which is the lower limit of the specification for the D4S type) or more, and an infrared range of visibility of 80 m or more can be satisfied when the radiation power ratio A is in a range of 3.0 to 1.8. In other words, this range of the radiation power ratio A indicates an appropriate range in which the infrared range of visibility can be made as large as possible within the specified range of the total luminous flux at a constant rated input of 35 W.

FIG. 10 is a circuit diagram illustrating an example of a metal halide lamp lighting apparatus according to the present invention. As shown in this figure, the metal halide lamp lighting apparatus includes a metal halide lamp 27 used for both a vehicle headlight and an infrared night imaging vision apparatus, and a lighting circuit OC.

The metal halide lamp 27 used for both a vehicle headlight and an infrared night imaging vision apparatus, may be of either one of the structures of the first and second embodiments.

The lighting circuit OC includes a direct current power 21, a chopper 22, control means 23, lamp current detection means 24, lamp voltage detection means 25, an igniter 26 and a full-bridge inverter 28. The circuit OC serves to light the metal halide lamp 27 by way of DC manner immediately after lighting, and then by way of AC manner.

The DC power 21 is power means that supplies a direct current to the chopper 22, as will be described later. As the DC power 21, a battery or a rectified direct current power source can be used. In the case of automobiles, a battery is usually employed. However, it may naturally be a rectified direct current power source that supplies a DC by rectifying an alternating current. In accordance with necessity, an electrolytic capacitor is connected in parallel to absorb noise or smooth the current.

The chopper 22 is a DC-DC converter circuit that converts a DC voltage into a desired value of DC voltage. It controls the metal halide lamp 27 via the full-bridge inverter 28, which will be described later, as desired. When the voltage of the DC power is low, the voltage increasing chopper is used, whereas when the voltage of the DC power is high, the voltage decreasing chopper is used.

The control means 23 serves to control the chopper 22. For example, immediately after lighting, the control means 23 makes the chopper 22 to supply a lamp current of three times as high as the rated lamp current to the metal halide lamp 27 via the full-bridge inverter 23. Then, as the time elapses, the control means controls the lamp current to gradually decrease eventually to the rated lamp current. Further, the lamp current, lamp voltage and detection signals that correspond to these are fed back to the control means 23 as will be described later. By this operation, the control means generates a constant power control signal to control the chopper 22 to generate a constant power. Further, the control means 23 is equipped with a microcomputer preprogrammed by a control pattern along with time. More specifically, it is programmed so that immediately after lighting, the control means 23 renders the chopper 22 to supply a lamp current of three times as high as the rated lamp current to the metal halide lamp 27, and then, as the time elapses, to gradually decrease the lamp current eventually to the rated lamp current.

The lamp current detection means 24 is inserted to be in series with the lamp via the full-bridge inverter 28, so as to detect a current corresponding to the lamp current and input it to the control means 13.

The lamp voltage detection means 25 is connected in parallel with the metal halide lamp 27 similarly via the full-bridge inverter 28, so as to detect a current corresponding to the lamp voltage and input it to the control means 23.

The igniter 26 is provided between the full-bridge inverter 28 and the metal halide lamp 27, so that it can supply a start pulse of about 20 kV to the metal halide lamp 27 when starting the lamp.

The full-bridge inverter 28 includes a bridge circuit 28a further including four MOSFETs Q1, Q2, Q3 and Q4, a gate drive circuit 28b that alternately switches MOSFETs Q1 and Q3 of the bridge circuit 28a over to each other and MOSFETs Q2 and Q4 over to each other, and a polarity inverting circuit INV. The inverter 28 serves to convert the DC voltage from the chopper 22 into a low-frequency alternating voltage of a rectangular wave by the above-mentioned switching, and apply the voltage to the metal halide lamp 27. Thus, the metal halide lamp 27 is lit in the low-frequency AC manner. It should be noted that in the DC lighting, which takes place immediately after starting of the lighting, for example, MOSFETs Q1 and Q3 of the bridge circuit 28a are continuously turned on, whereas Q2 and Q4 are turned off.

As described above, when the metal halide lamp 27 is lit at the start of lighting by the DC manner and then by the manner of the low-frequency AC of the rectangular wave, a desired luminous flux can be generated from the start of lighting. Thus, when the metal halide lamp lighting apparatus of this example is built in the vehicle headlight, it is possible to achieve 25% of the luminous flux with respect to the rating of this lamp one second after starting the power and 80% of the luminous flux four seconds-after.

1. A metal halide lamp used for both of a vehicle headlight and an infrared night imaging vision apparatus, the metal halide lamp comprising:
a refractory and light-transmitting hermetic vessel;
a pair of electrodes sealed in the hermetic vessel; and
a substantially mercury-free discharge medium sealed in the hermetic vessel and including a first halide containing at least one of sodium (Na), scandium (Sc) and a rare earth metal, a second halide which is a halide of a metal which emits light mainly in a near-infrared region of a wavelength of 780 to 800 nm, and a gas which emits light mainly in a near-infrared region of a wavelength of 820 to 1000 nm.

2. The metal halide lamp according to claim 1, wherein a ratio between a radiation power of a visible region in a wavelength of 380 to 780 nm and that of a near-infrared region of a wavelength of 780 to 1200 nm is 3.2:1 to 2.0:1 while the lamp is stably lit at constant rated input.

3. The metal halide lamp according to claim 1, wherein a ratio between a radiation power of a near infrared region in a wavelength of 780 to 800 nm and that of a near-infrared region of a wavelength of 780 to 1000 nm is 0.1:1 to 0.33:1 while the lamp is stably lit at a constant rated input.

4. The metal halide lamp according to claim 2, wherein a ratio between a radiation power of a near infrared region in a wavelength of 780 to 800 nm and that of a near-infrared region of a wavelength of 780 to 1000 nm is 0.1:1 to 0.33:1 while the lamp is stably lit at constant rated input.

5. The metal halide lamp according to claim 1, wherein the metal that emits light mainly in a near-infrared region of a wavelength of 780 to 800 is rubidium (Rb).

6. The metal halide lamp according to claim 5, wherein an amount of a halide of rubidium (Rb) is 0.2 to 8 mg per internal volume of 1 cc of the hermetic vessel.

7. The metal halide lamp according to claim 1, wherein the discharge medium contains the third halide having a relatively high vapor pressure and being a halide of at least one kind of metal that emits a visible light less than that emitted by the metal of the first halide.

8. The metal halide lamp according to claim 1, wherein the first halide contains halides of sodium (Na) and scandium (Sc) as its main contents.

9. The metal halide lamp according to claim 1, wherein the gas that emits light mainly in a near-infrared region of a wavelength of 820 to 1000 is xenon (Xe).

10. The metal halide lamp according to claim 9, wherein a pressure for sealing xenon (Xe) is 6 atmospheres or higher.

11. The metal halide lamp according to claim 1, wherein a rated lamp power is in a range of 35±3 W.

12. The metal halide lamp according to claim 1, wherein the lamp is of the D3S or D4S type, and the total luminous flux is 2750 lm or more.

13. The metal halide lamp according to claim 1, wherein the lamp is of the D3R or D4R type, and the total luminous flux is 2350 lm or more.

14. The metal halide lamp according to claim 1, wherein, mainly, a near-infrared light having a wavelength of 760 nm or higher is utilized by the night imaging vision apparatus.

15. A metal halide lamp used for both of a vehicle headlight and an infrared night imaging vision apparatus, the metal halide lamp comprising:
a refractory and light-transmitting hermetic vessel;
a pair of electrodes sealed in the hermetic vessel; and
a substantially mercury-free discharge medium sealed in the hermetic vessel and including a first halide containing at least one of sodium (Na), scandium (Sc) and a rare earth metal, a second halide of a metal which emits light mainly in a near-infrared region of a wavelength of 840 to 930 nm, and a gas which emits light mainly in a near-infrared region of a wavelength of 820 to 1000 nm,
wherein the visible light is used for the vehicle headlight and the near-infrared light is used for the infrared night imaging vision apparatus at the same time.

16. The metal halide lamp according to claim 15, wherein a ratio between a radiation power of a visible region in a wavelength of 380 to 780 nm and that of a near-infrared region of a wavelength of 800 to 1200 nm is 3.1:1 to 1.8:1 while the lamp is stably lit at constant rated input.

17. The metal halide lamp according to claim 16, wherein the metal that emits light mainly in a near-infrared region of a wavelength of 840 to 930 is cesium (Cs).

18. The metal halide lamp according to claim 17, wherein an amount of a halide of cesium (Cs) is 0.2 to 10 mg per internal volume of 1 cc of the hermetic vessel.

19. The metal halide lamp according to claim 15, wherein the discharge medium contains the third halide having a relatively high vapor pressure, and being a halide of at least one kind of metal that emits a visible light less than that emitted by the metal of the first halide.

20. The metal halide lamp according to claim 15, wherein the first halide contains halides of sodium (Na) and scandium (Sc) as its main contents.

21. The metal halide lamp according to claim 15, wherein the gas that emits light mainly in a near-infrared region of a wavelength of 820 to 1000 is xenon (Xe).

22. The metal halide lamp according to claim 21 wherein a pressure for sealing xenon (Xe) is 6 atmospheres or higher.

23. The metal halide lamp according to claim 15, wherein a rated lamp power is in a range of 35±3 W.

24. The metal halide lamp according to claim 15, wherein the lamp is of the D3S or D4S type, and the total luminous flux is 2750 lm or more.

25. The metal halide lamp according to claim 15, wherein the lamp is of the D3R or D4R type, and the total luminous flux is 2350 lm or more.

26. The metal halide lamp according to claim 15, wherein, mainly, a near-infrared light having a wavelength of 800 nm or higher is utilized by the night imaging vision apparatus.

27. A metal halide lamp lighting apparatus comprising:
a metal halide lamp used for both a vehicle headlight and an infrared night imaging vision apparatus, according to claim 1; and
a lighting device configured to urge the metal halide lamp used for both the vehicle headlight and infrared night imaging vision apparatus.
